(19) United States
(12) Patent Application Publication
(10) Pub. No.: US 2008/0176435 A1
(43) Pub. Date: Jul. 24, 2008

(54) Electrical Connector for Flat Cable

(76) Inventor: Masaaki Iwasaki, Kanagawa (JP)

Correspondence Address: BARLEY SNYDER, LLC, 1000 WESTLAKES DRIVE, SUITE 275, BERWYN, PA, 19312, US

(21) Appl. No.: 11/941,635

(22) Filed: Nov. 16, 2007

(30) Foreign Application Priority Data
Nov. 17, 2006 (JP) 2006-311071

(51) Int. Cl. H01R 13/62

(52) U.S. Cl. 439/260

(57) ABSTRACT

An electrical connector for a flat cable having a housing is disclosed. The housing holds a cantilever-shaped contact and a shield plate is engaged with the housing so that the shield plate presses the flat cable against the contact.

### CROSS-REFERENCE TO RELATED APPLICATION DATA

This application claims the benefit of the earlier filed JP Patent Application No. 2006-311071 having a filing date of Nov. 17, 2006.

### FIELD OF THE INVENTION

The present invention relates to an electrical connector for flat cables.

### BACKGROUND

Known electrical connectors for flat cables include those disclosed in Japanese Patent Publication Nos. 10-189174 and 2006-66242.

Japanese Patent Publication No. 10-189174 discloses an invention providing an electrical connector which can be assembled in a high density component configuration, allowing a flexible printed circuit (hereinafter referred to as FPC) to be easily engaged or disengaged with the connector, and provided with a noise-suppression measure. It is illustrated in Prior Art FIG. 16, where an electrical connector 100 has first and second contacts 110 and 120, respectively, with respective first and second contacting parts 111 and 121 disposed in the vertical direction to have a two-tiered structure while being spaced from each other. Electrical connector 100 also comprises a metallic shell 130. An FPC 180 is inserted into the electrical connector 100 at an angle through a fitting port of the electrical connector 100. The FPC 180 is rotated in the arrowed direction relative to the electrical connector 100 once the FPC 180 is completely inserted into the electrical connector 100. When the connector 100 is mounted on and electrically connected to a printed circuit board (hereinafter referred to as PCB) via a grounding part, the shell 130 provides a noise-suppression function to prevent intrusion of electromagnetic noises into the connector 100 and/or to prevent leak of electromagnetic noises from the connector 100.

Japanese Patent Publication No. 2006-66242 discloses an electrical connector 200 for flat cables which can provide a noise-suppression function. Referring to Prior Art FIG. 17, the connector 200 comprises a contact 220 and an insulative housing 250 for holding the contact 200, wherein the contact 220 comes into contact with an inserted flat cable 210 via a signal conductor, and the housing 250 is substantially covered with a shield plate 260. The contact 220, has a tuning fork shape and comprises a contact arm 220a and pressing arm 220b where the former comes into contact with a flat cable 210 terminal. The pressing arm 220b is pressed upward by a locking member 270 thereby pressing the contact arm 220a toward the flat cable 210. The connector 200 also comprises a shield layer 210s on the flat cable 210 and shield plate 260 electrically connected to the shield layer 210s. The shield plate 260 is electrically connected to a grounding part 281 on of a PCB 280 on which the connector 200 is mounted.

The electrical connectors 100 and 200 for flat cables have been used for electronic devices, e.g., cellular phones. However, demand to reduce electrical connector height increases as electronic devices are becoming smaller. The electrical connector 100 for flat cables disclosed in Japanese Patent Publication No. 10-189174 cannot cope well with the above requirement because it has a two-tiered structure with the first and second contacts 110 and 120, on which the shell 130 capable of functioning as a shield plate is mounted. The electrical connector 200 for flat cables disclosed by Japanese Patent Publication No. 2006-66242 also cannot cope well with the reduced height requirement, because it has the tuning fork shaped contact 220 and the shield plate 260 on the insulative housing 250.

### SUMMARY

The present invention relates to, in one embodiment among others, an electrical connector for a flat cable having a housing. The housing holds a cantilever-shaped contact and a shield plate is engaged with the housing so that the shield plate presses the flat cable against the contact.

### BRIEF DESCRIPTION OF THE DRAWINGS

FIG. 1 is an oblique view illustrating a first embodiment of an electrical connector for a flat cable;

FIG. 2 is an oblique exploded view illustrating major components of the electrical connector according to the embodiment of FIG. 1;

FIG. 3 is an oblique view illustrating the electrical connector according to the embodiment of FIG. 1, with the shield plate removed from the connector;

FIGS. 4A, 4B, and 4C are orthogonal views illustrating the connector of the embodiment of FIG. 1 with the shield plate omitted, where FIG. 4A is a front view thereof, FIG. 4B is a plan view thereof and FIG. 4C is a back view thereof;

FIGS. 5A, 5B, and 5C are orthogonal views that illustrate the shield plate of the electrical connector according to the embodiment of claim 1;

FIG. 6 is an orthogonal view illustrating the FPC connected to the electrical connector according to the embodiment of FIG. 1;

FIG. 7 is an orthogonal side view of the electrical connector according to the embodiment of FIG. 1;

FIG. 8 is an orthogonal cross-sectional view of the electrical connector according to the embodiment of FIG. 1, cut along the line 8a-8a in FIG. 4B;

FIG. 9 is the cross-section shown in FIG. 8 with the FPC inserted into the connector according to the embodiment of FIG. 1;

FIG. 10 is an orthogonal plan view illustrating a second embodiment of an electrical connector for a flat cable;

FIG. 11 is an orthogonal plan view illustrating a shield plate for the electrical connector of FIG. 10;

FIG. 12 an orthogonal plan view illustrating a third embodiment of an electrical connector for a flat cable;

FIG. 13 is an orthogonal plan view illustrating a shield plate for the electrical connector of FIG. 12;

FIG. 14 is an orthogonal plan view illustrating an FPC provided with a shield layer;

FIG. 15 is an orthogonal cross-sectional view illustrating the electrical connector, into which an FPC provided with the shield layer is inserted;

Prior Art FIG. 16 is a cross-sectional view illustrating an electrical connector for a flat cable, disclosed by Japanese Patent Publication No. 10-189174; and

Prior Art FIG. 17 is a cross-sectional view illustrating an electrical connector for a flat cable, disclosed by Japanese Patent Publication No. 2006-66242.

### DETAILED DESCRIPTION OF THE EMBODIMENTS

The flat cable for use in and/or association with the present invention encompasses a concept which includes a cable referred to as flexible flat cable (FFC) in which a plurality of electric wires run in parallel to each other in a flat-shaped insulator and one referred to as FPC, described above.

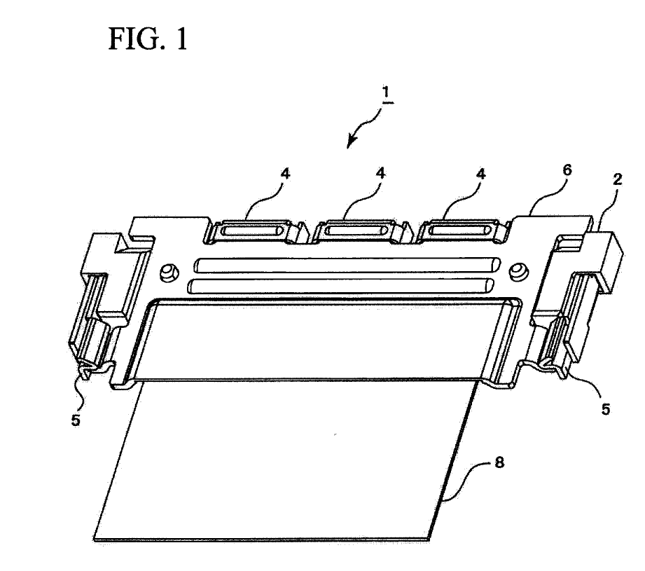

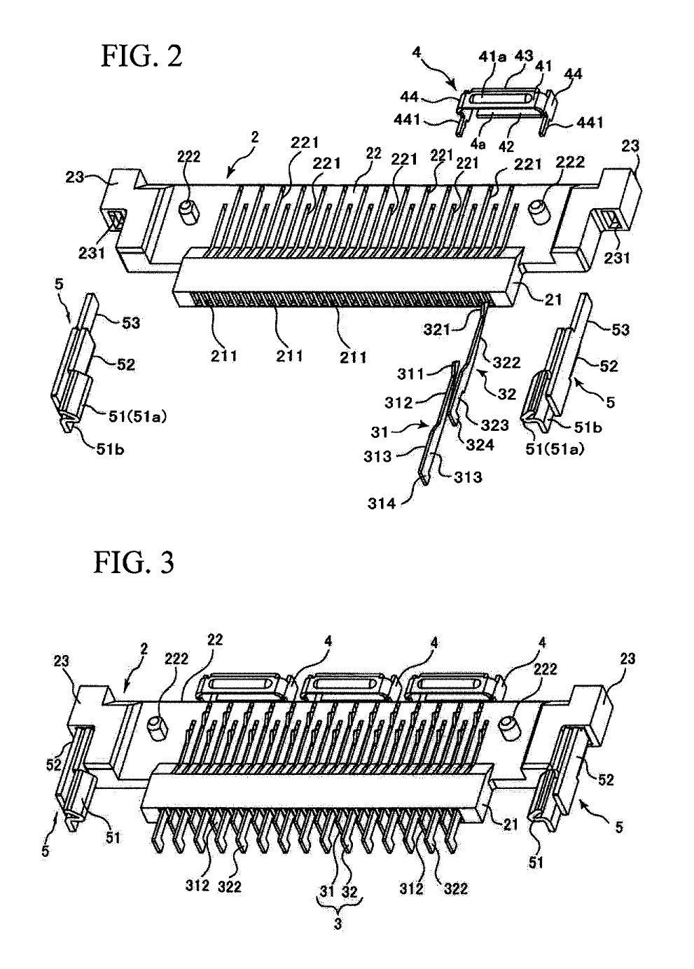

The embodiments of the electrical connector for a flat cable of the present invention are described with reference to the attached drawings, which show an electrical connector 1 for a flat cable (hereinafter simply referred to as connector 1). FIGS. 1 to 3 show external views of the connector 1 according to a first embodiment. The connector 1 comprises an insulative housing 2 (hereinafter simply referred to as housing 2), a plurality of contacts 3 arranged at given intervals on the housing 2, a shield plate 6 covering the housing 2 on the side having contacts 3, and pegs 4 and latches 5 fixing the shield plate 6 on the housing 2. The connector 1 electrically connects the FPC 8 to other components, e.g., a PCB (not shown) via the contacts 3. In the connector 1, the shield plate 6 has suppresses electromagnetic noise to prevent intrusion of electromagnetic noises into the connector 1 and/or to prevent leakage of electromagnetic noises from the connector 1. Moreover, the shield plate 6 presses the contacts 3 and FPC 8 to secure electrical connection between them. Contacts 3 have a cantilever shape that in combination with the shield plate 6, provides the connector 1 with decreased height.

The connector 1 is described with the housing 2 having a front side, from which the FPC 8 extends when properly associated with the connector 1, and an opposite back side.

The housing 2 is provided with a contact grip frame 21 for gripping and holding the contacts 3, a substantially rectangular contact receptacle frame 22 extends to one side of the contact grip frame 21, and latch receptacle frames 23 are disposed at both longitudinal ends of the contact receptacle frame 22. The contact grip frame 21, contact receptacle frame 22, and latch receptacle frames 23 are, in this embodiment, fabricated by injection molding to have an integral structure so that they collectively constitutes the housing 2.

The contact grip frame 21 is provided with a plurality of holes press-fit holes 211 into which the contacts 3 are pressed. The press-fit holes 211 are arranged to run parallel to each other along the width direction of the contact grip frame 21. The press-fit holes 211 extend through the contact grip frame 21 in the direction perpendicular to the width direction of the contact grip frame 21. The contacts 3 are held by the housing 2 when pressed into the press-fit holes 211.

The contact receptacle frame 22 is provided with a plurality of contact channels 221 in which the contacts 3 are housed. The contact channels 221 are arranged to run in parallel to each other along the contact receptacle frame 22 width direction. Each of the contact channels 221 is in communication with a corresponding press-fit hole 211. Each contact 3 is disposed in both a press-fit hole 211 and a corresponding contact channel 221. The contacts 3 are elastically deformable and the portions of the contacts 3 housed in the contact channels 221 are movable in the vertical direction.

The contact receptacle frame 22 is provided with two positioning protrusions 222 on the surface, one of them is located at one width direction end and the other at the other width direction end. One of the positioning protrusions 222 is fit into a shield plate positioning hole 64 in the shield plate 6 and the other is fit into an FPC positioning hole 822 in the FPC 8, to position the shield plate 6 and FPC 8 on the housing 2. These positioning holes are further described later.

The latch receptacle frame 23 is provided with a latch receptacle 231, into which the latch 5 is pressed into to be secured.

The contacts 3 are provided as two types of contacts, a first contact 31 and a second contact 32, which are generally fabricated by punching (stamping) a copper alloy sheet having high elasticity and electroconductivity.

The first contact 31 comprises a first contacting part 311 located at the end on the housing 2 front side, elastically deformable first deformable part 312 which includes the first contacting part 311, first fixing part 313 adjacent to the first deformable part 312, and first tine 314 adjacent to the first fixing part 313. Similarly, the second contact 32 comprises a second contacting part 321 located at the end on the housing 2 front side, elastically deformable second deformable part 322 which includes the second contacting part 321, second fixing part 323 adjacent to the second deformable part 322, and second tine 324 adjacent to the second fixing part 323.

The first contacts 31 and second 32 are inserted into the press-fit holes 211 from the back side of housing 2. The first and second fixing parts 313, 323 of the first and second contacts 31, 32, respectively, are pressed into the press-fit holes 211. The first and second fixing parts 313, 323 form the secured end of the cantilever-shaped contacts 3. The elastically deformable first and second deformable parts 312, 322 are held in the contact channels 221 so that the first and second deformable parts 312, 322 can elastically deform even while within contact channels 221. The first and second contacting parts 311, 321 at the free ends of the first and second contacts 31, 32, respectively, are not pressed by the shield plate 6 and protrude from the upper side of the contact receptacle frame 22 with which the FPC 8 is in contact. The first and second contacting parts 311, 321 extend from the holding grooves 221 and contact the FPC 8. The first and second contacting parts 311, 321 are electrically connected to terminals 821 of the FPC 8. The first and second contacts 31, 32 have their first and second contacting parts 311, 321, respectively, arranged at given intervals in the contact receptacle frame 22 width direction. This arrangement corresponds to that of the terminals 821 of the FPC 8, described later. The first and second contacts 31, 32 have first tines 314 and second tines 324, respectively, at the ends opposite to the first and second contacting parts 311, 321. The first and second tines 314, 324 protrude toward a base plane 2a of the housing 2, when the first contact 31 and second contacts 32 are pressed into the housing 2 to be secured. When the housing 2 is mounted on a PCB (not shown), the first and second tines 314, 324 are, in this embodiment, surface mounted on the PCB, and more specifically, are soldered to a land (conductor pattern) on the PCB.

The pegs 4 hold the shield plate 6 on the back side of connector 1. The pegs 4 are electrically connected to the shield plate 6 and can ground it when they are soldered to the PCB land. The pegs 4 also function to secure the housing 2 on the PCB.

Each of the pegs 4 has an upper wall 41 and lower wall 42 spaced from each other by a given distance, connected to each other by a rear wall 43. It also has side walls 44 running downwards from each width direction end of the upper wall 41. Hence, the peg 4 is substantially box-shaped with a peg receptacle 4a. The peg 4 is, in this embodiment, made of a metal, e.g., copper alloy, and fabricated by punching and bending to have an integral structure. The pegs 4 have notches between the lower wall 42 and side wall 44, and between the rear wall 43 and side wall 44. Hence, the upper wall 41 and lower wall 42 are provided with elasticity on the rear wall 43. The upper wall 41 is provided with an upper wall strengthener 41 a on the upper side. The pegs 4 are members having a mechanical structure for holding the shield plate 6, and the upper wall strengthener 41 a is provided to improve its strength, as discussed later in detail.

The side wall 44 of the peg 4 is provided with a peg protrusion 441, which is pressed in a hole provided on the housing 2 to secure the peg 4 on the back side of the connector 1. The peg 4, when secured on the back side of the connector 1, has the peg receptacle 4a protruding upward over the contact receptacle frame 22 of the housing 2. A tab 63, described later, of the shield plate 6 is inserted into a space between the protruding portion of the peg receptacle 4a and the upper side of the contact receptacle frame 22.

The connector 1 of this embodiment has three pegs 4 of the same type. It can be secured with a single peg longer in the width direction. However, use of a required number of smaller pegs suitable for connector size (length) is more advantageous for decreasing the number of parts than use of pegs of different size for producing connectors of different width.

The connector 1 has first and second tines 314, 324 of the respective first and second contacts 31, 32 arranged on the front side of housing 2. This structure is effective for decreasing the peg 4 height. The first and second fixing parts 313, 323 of the respective first and second contacts 31, 32 are taller than other parts. Hence, the first and second fixing parts 313, 323, when disposed in the vicinity of the back side, need the higher peg 4.

The latch 5 works to hold the shield plate 6. The latches 5 disposed at the housing 2 ends in the width direction, along with the pegs 4, secure the shield plate 6 on the housing 2.

The latch 5 comprises a latch body 51 by which the shield plate 6 is held, with rigid part 52 adjacent to the latch body 51, and press-fit part 53 adjacent to the rigid part 52. In this embodiment, the latch 5 is made of a metal, e.g., stainless steel, and fabricated by punching and bending to have an integral structure.

The latch 5 is secured on the housing 2, when its press-fit part 53 is pressed into a latch receptacle 231 of the housing 2. The latch body 51 comprises a flat-plate part 51b and curved part 51a has a C-shaped cross-section and is adjacent to the flat-plate part 51b. The curved part 51a can be elastically deformable on the flat-plate part 51b. When the latch 5 holds the shield plate 6 by the latch body 51, the shield plate 6 presses the FPC 8 against the contacts 3 with significant pressure partly because of presence of the rigid part 52 between the latch body 51 and press-fit part 53.

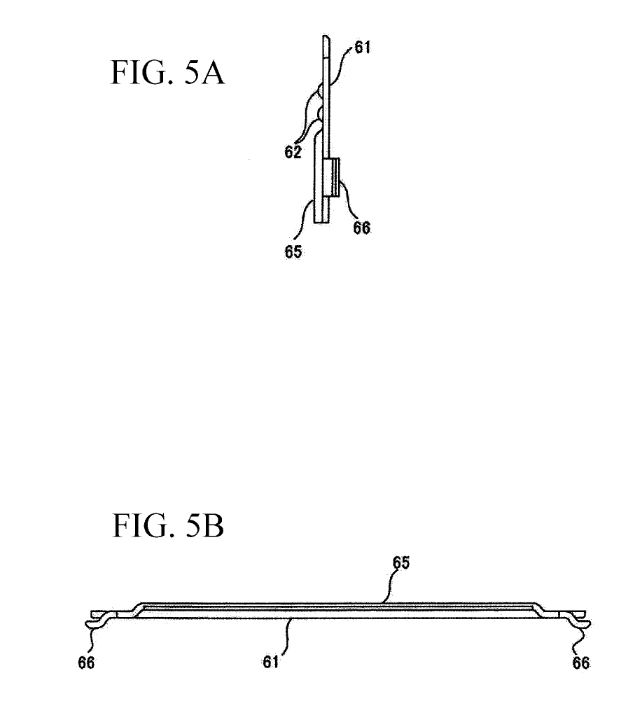

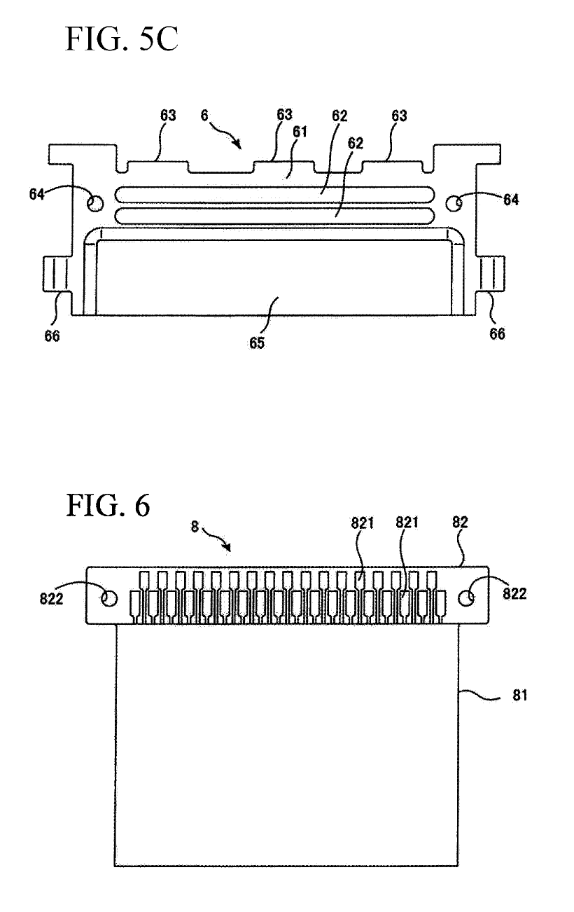

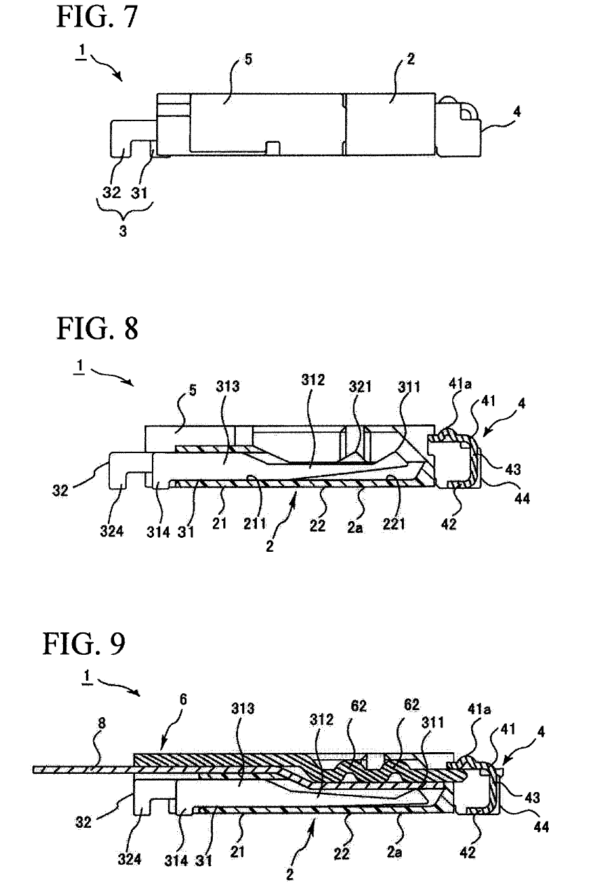

FIGS. 5A-5C illustrates three orthogonal views of the shield plate 6. The shield plate 6 works to prevent intrusion of electromagnetic noises into the connector 1 and/or to prevent leakage of electromagnetic noises from the connector 1. The shield plate 6 of this embodiment also presses the FPC 8 against the contacts 3. Noise-suppression is accomplished when the pegs 4 are electrically connected to the grounding part on the PCB. In this embodiment, the shield plate 6 is made of a high-electroconductive metal, e.g., copper alloy. In this embodiment, the flat, rectangular shield plate 6 is fabricated by punching and bending of a single metallic plate.

The shield plate 6 comprises a first section 61 and second section 65, and is secured on the housing 2 by the pegs 4 and latches 5, as discussed above.

The first section 61 covers the electrically connected portion between the contacts 3 and FPC 8 terminals 821 to exhibit a noise-suppression function for that portion. Moreover, it presses the FPC 8 to secure the electrical connection between the contacts 3 and FPC 8 terminals 821.

The first section 61 is provided with two shield plate strengtheners 62 running parallel to each other in the width direction. These shield plate strengtheners 62 work to increase rigidity of the first section 61. Increasing the number of contacts 3 increases a total reaction force from the contacts 3, which results from pressing contacts 3 via the FPC 8. Hence, the shield plate strengthener 62 is more needed as the number of the contacts 3 increases. It should be noted, however, that the shield plate strengthener 62 is not essential for the present invention.

The first section 61 is provided with tabs 63 held by the pegs 4. It has three tabs 63 corresponding to the number of the pegs 4. The tab 63 is inserted into a gap formed between the peg 4 peg receptacle 4a and upper side of the contact receptacle frame 22.

The first section 61 is also provided with positioning holes 64, into which the positioning protrusions 222 on the housing 2 are inserted to secure positioning accuracy of the shield plate 6 on the housing 2.

The second section 65 covers the FPC 8 to exhibit a noise-suppression function. It also presses the FPC 8. The noise-suppression function is particularly required for the portions which electrically connect the contacts 3 and FPC 8 terminals 821. The second section 65 is subjected to a smaller reaction force from the contacts 3 than the first section 61, and is optional depending upon a specific application. In this embodiment, the second section 65 is provided to increase rigidity of the shield plate 6 as a whole, because it is subjected to an increased reaction force when the number of the contacts 3 is large.

The second section 65 is provided with a pair of wings 66 corresponding to the latches 5 at both the ends in the width direction. The tab 63 of the first section 61 engages with the peg 4 while the wing 66 of the second section 65 with the latch 5 to secure the shield plate 6 on the housing 2.

FIG. 6 is a plan view of the FPC 8. The FPC 8 comprises a cable body 81 and terminal part 82. The cable body 81 comprises a plurality of conductors over molded with an insulator, both of the conductors and insulator are not shown.

The conductors are arranged to run in parallel to each other at given intervals, and are electrically connected to terminals 821 of the terminal part 82. The terminals 821 are electrically connected to the contacts 3. The terminal part 82 is provided with positioning holes 822 at both ends in the width direction. The positioning protrusions 222 of the housing 2 are fit into the positioning holes 822 to secure positioning accuracy of the FPC 8 on the housing 2.

Next, how the connector 1 is assembled is outlined.

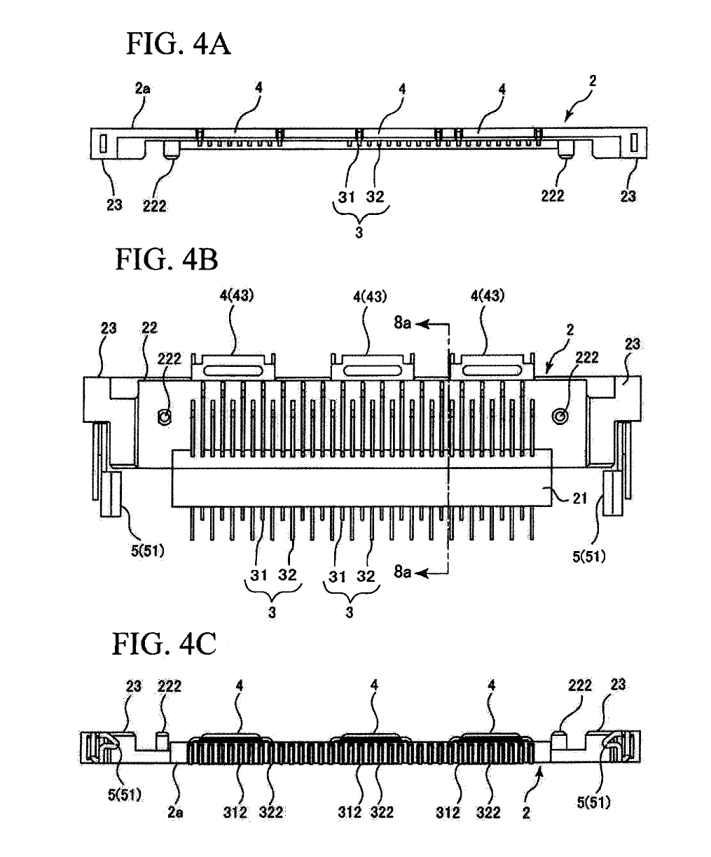

First, the housing 2 with the contacts 3, pegs 4 and latches 5 disposed at given positions is prepared. FIGS. 3 and 4 illustrate the housing 2 in the above conditions, wherein the contacts 3 have free ends. Hence, the first and second contacting parts 311, 321 of the first and second contacts 31, 32 protrude from the upper side of the contact receptacle frame 22, as illustrated in FIG. 8.

Next, the FPC 8 is disposed at a given position in the housing 2. The FPC 8 is disposed in such a way that the plane on which the terminals 821 are provided faces the first and second contacting parts 311, 321 of the first and second contacts 31, 32. The FPC 8 can be accurately positioned at a given position in the housing 2 by fitting the positioning protrusions 222 of the housing 2 into the FPC positioning holes 822 of the FPC 8.

The shield plate 6 is secured on the housing 2 by the following procedures, after the FPC 8 is disposed. First, each of the tabs 63 of the shield plate 6 is inserted into the peg receptacles 4a formed between the peg 4 and housing 2, the shield plate 6 being slanted in relation to the housing 2 at this stage.

Then, the shield plate 6 is pressed downward to be substantially parallel to the housing 2. The shield plate 6 rotates around the tabs 63 side, which expands the latches 5 by the wings 66 of the shield plate 6 and finally allows the wing 66 to engage with lower side of the latch 5. This mounts the shield plate 6 on the housing 2, and completes assembling the connector 1.

FIG. 9 illustrates the FPC 8 and shield plate 6 mounted on the housing 2. Mounting the FPC 8 and shield plate 6 moves the first and second contacting parts 311, 321 of the contacts 3 (first contacts 31 and second contacts 32) downward from the positions shown in FIG. 8, and allows the first and second contacting parts 311, 321 to wipe the terminals 821 to help achieve the electrical connection between the contacts 3 and terminals 821 of the FPC 8. Moreover, the reaction force created while the first and second contacting parts 311, 321 of the contacts 3 move downward aides retention of the electrical connection. In other words, the electrical connection may be insufficient when the reaction force is insufficient.

The connector 1 is intended to be short in height. It is however necessary to take the following into consideration, when thickness of the FPC 8 is decreased, a reaction force may be insufficient when travel distance of the first and second contacting parts 311, 321 of the contacts 3 moving downward is set as the same distance as the thickness of the FPC 8. Hence, the travel distance of the first and second contacting parts 311, 322 is set at longer than the thickness of the FPC 8. More specifically, the first and second contacting parts 311, 321 of the contacts 3 are positioned in such a way that they interfere with the shield plate 6 when the shield plate 6 is mounted on the housing 2 while the first and second contacting parts 311, 322 are under no load (conditions illustrated in FIG. 8). In this embodiment, the first and second contacting parts 311, 322 protrude from the housing 2. This structure allows the contacts 3 to be sufficiently pressed against the FPC 8 to secure electrical connection between them, even with a thin FPC 8.

The connector 1 described above also creates a pressing force to secure the electrical connection of the shield plate 6 to the contacts 3 and FPC 8. Hence, the cantilever-shaped contacts 3, which are advantageous for decreasing height of the connector 1, can be designed mainly taking into consideration the electrical connection. More specifically, the connector 1 of the present invention can reduce its height by at least half that of tuning fork shaped contacts. Moreover, the connector 1 can advantageously reduce the number of components, because its shield plate 6 also has a noise-suppression function.

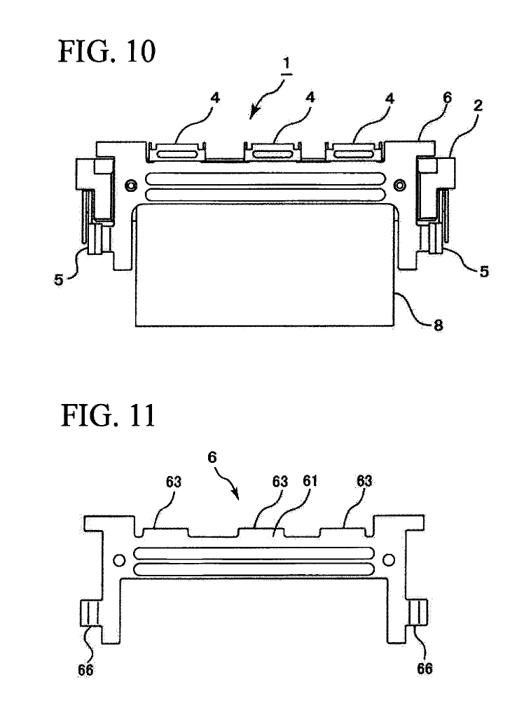

The shield plate 6, in this embodiment, has the first section 61 and second section 65. However, the connector 1 can have the shield plate 6 may, in alternative embodiments, not comprise a second section 65, as illustrated in FIGS. 10 and 11, because the shield plate 6 may be required to be less rigid when the number of the contacts 3 is small, as discussed above.

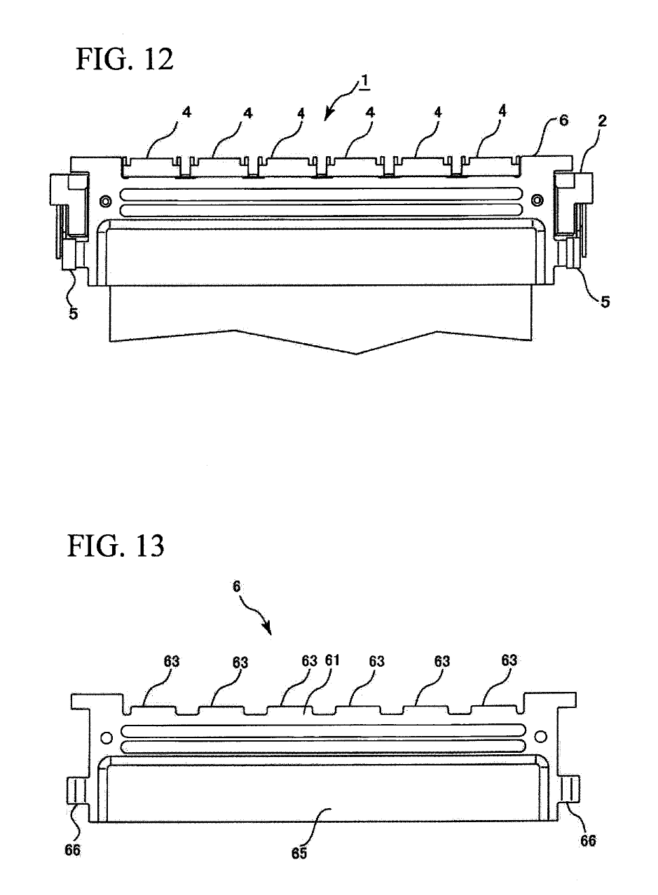

When the number of the contacts 3 is large, on the other hand, the number of the pegs 4 and corresponding tabs 63 of the shield plate 6 may be increased, as illustrated in FIGS. 12 and 13. Increasing the number of the contacts 3 increases a reaction force, which pushes the shield plate 6 up against the force pressing the shield plate 6 downward. Such a reaction force may warp the shield plate 6 to form a convex bend in the shield plate 6 in the reaction force direction at the widthwise center of the shield plate 6, when the shield plate 6 has an insufficient rigidity. Hence, the tabs 63 and pegs 4 are engaged with each other to increase shield plate 6 rigidity. Second section 65 is included in this embodiment. Alternatively, the shield plate 6 can be secured on one or more other places. For example, it may be secured on the housing 2 at both ends in the width direction on the front side, in addition to on the back side.

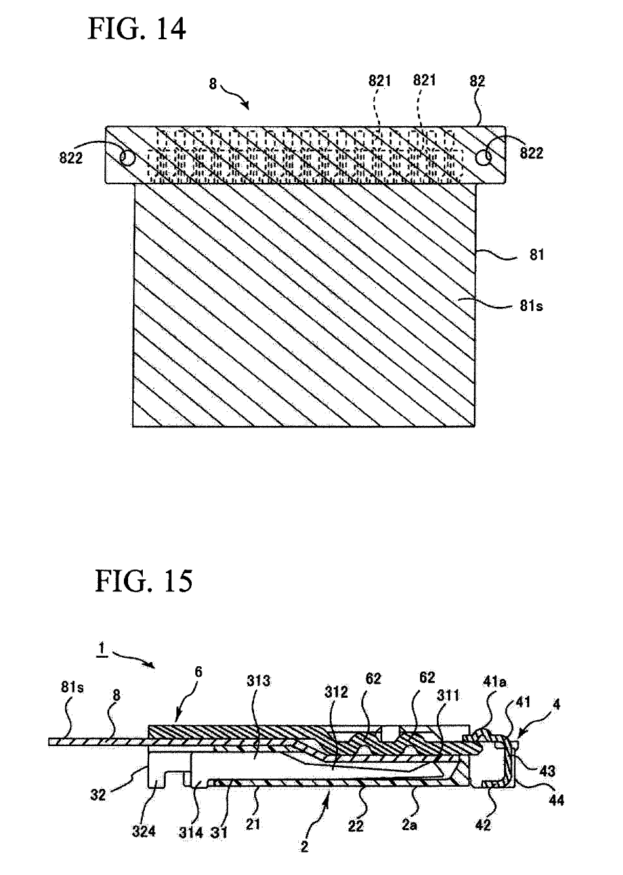

In the connector 1, the FPC 8 may be provided with an FPC shield layer 81s on the surface, as illustrated in FIG. 14. The FPC shield layer 81s may be made of an electroconductive material, e.g., aluminum, and is disposed to come into contact with the shield plate 6. It is grounded to a grounding part on the PCB via the shield plate 6 and pegs 4.

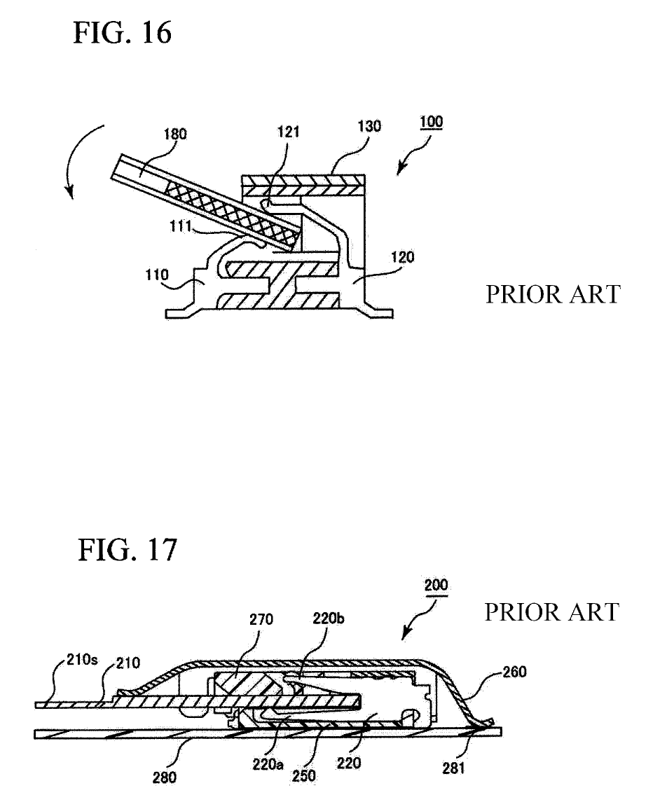

In the connector 1, the first and second tines 314, 324 to be soldered to the PCB are disposed on the housing 2 front side, from which the FPC 8 extends when the FPC 8 is properly associated with the connector 1. As a result, the contacts 3 (first and second contacts 31, 32) including the first and second tines 314, 324 are totally covered with the FPC shield layer 81s, when the cable body 81 provided with the FPC shield layer 81s is inserted into the connector 1, as illustrated in FIG. 15. Hence, this structure further improves noise-suppression function of the connector 1.

The connector 1 described above merely represents one preferred embodiment of the present invention. Hence, it may be altered within limits not departing from the essence of the present invention.

For example, the shield plate 6 may be secured on the housing 2 by a procedure different from the one described above, where the connector 1 has the pegs 4 and latches 5 as members separate from the housing 2. The members corresponding to at least one of the pegs 4 and latches 5 may be formed to be integral with the housing 2.

In the connector 1, the shield plate 6 is secured on back side of the housing 2 by the pegs 4, which is advantageous for imparting high rigidity to the shield plate 6, as discussed above. However, the present invention is not limited to the above embodiment. For example, the shield plate 6 may be secured on the housing 2 at both the ends in the width direction which would be advantageous when the number of the contacts 3 is small.

The connector 1 is advantageously short in height and the cantilever-shaped contacts 3 in combination with the shield plate 6 allow the electrical connector 1 to suppress noise even with the short height.

What is claimed is:

1. An electrical connector for a flat cable, comprising:
a housing;
a cantilever-shaped contact held by the housing; and
a shield plate engaged with the housing so that the shield plate presses the flat cable against the contact.

2. The electrical connector according to claim 1, wherein the shield plate is a metallic plate that covers at least an area in which the flat cable contacts the contact.

3. The electrical connector according to claim 1, the housing comprising:
a front side from which the flat cable is inserted or removed;
a back side opposite the front side, and
wherein the shield plate engages the housing at least on the back side.

4. The electrical connector according to claim 3, the contact comprising:
a fixing part secured to the housing in a fixed position;
an elastically deformable part adjacent to the fixing part; and
a tine adjacent to the fixing part.

5. The electrical connector according to claim 4, wherein the elastically deformable part and the tine are disposed opposite each other about the fixing part.

6. The electrical connector according to claim 4, wherein the elastically deformable part is located nearer the back side of the housing than the tine.

7. The electrical connector according to claim 6, the elastically deformable part comprising a contacting part connected to the flat cable.

8. The electrical connector according to claim 4, wherein when the tine is electrically connected to a PCB.

9. The electrical connector according to claim 4, wherein when the elastically deformable part is unrestricted, the contact protrudes from the a surface of the housing that contacts the flat cable.

10. The electrical connector according to claim 4, wherein the elastically deformable part is biased away from the housing.

11. The electrical connector according to claim 1, wherein the shield plate comprises a tab received within a peg of the housing.

12. The electrical connector according to claim 1, wherein the shield plate comprises a wing retained by a latch of the housing.

13. The electrical connector according to claim 1, wherein the shield plate prevents obstructs transmission of electromagnetic noise therethrough.

14. The electrical connector according to claim 1, the shield plate comprising:
a shield plate strengthener.

15. The electrical connector according to claim 1, the housing comprising:
a contact grip frame having a press-fit hole that holds the contact.

16. The electrical connector according to claim 1, the housing comprising:
contact receptacle frame having a contact channel that receives the contact.

17. The electrical connector according to claim 16, wherein at least a portion of the contact received in the contact channel is movable in a vertical direction.

18. The electrical connector according to claim 1, the housing comprising:
a latch receptacle frame having a latch receptacle that receives a latch.

19. The electrical connector according to claim 18, the latch comprising:
a latch body that releasably holds the shield plate relative to the housing by engaging a wing of the shield plate.

20. The electrical connector according to claim 1, the housing comprising:
a peg electrically connected to the shield plate and soldered to a PCB land.
